(19) United States
(12) Patent Application Publication
(10) Pub. No.: US 2013/0081239 A1
(43) Pub. Date: Apr. 4, 2013

(54) METHOD OF MANUFACTURING ACTUATOR FOR MICRO EJECTOR

(71) Applicants: Sang Jin KIM, Suwon (KR); Bo Sung Ku, Suwon (KR)

(72) Inventors: Sang Jin KIM, Suwon (KR); Bo Sung Ku, Suwon (KR)

(73) Assignee: SAMSUNG ELECTRO-MECHANICS CO., LTD.

(21) Appl. No.: 13/364,970

(22) Filed: Feb. 2, 2012

(30) Foreign Application Priority Data
Sep. 30, 2011 (KR) 10-2011-0099786

(51) Int. Cl. H04R 17/00

(52) U.S. Cl. 29/25.35

(57) ABSTRACT

There is provided a method of manufacturing an actuator for a micro ejector. The method of manufacturing an actuator for a micro ejector may include: forming grooves in a first surface of a piezoelectric element; attaching the first surface of the piezoelectric element to a substrate; and machining a second surface of the piezoelectric element.

### CROSS-REFERENCE TO RELATED APPLICATIONS

This application claims the priority of Korean Patent Application No. 10-2011-0099786 filed on Sep. 30, 2011 in the Korean Intellectual Property Office, the disclosure of which is incorporated herein by reference.

### BACKGROUND OF THE INVENTION

1. Field of the Invention

The present invention relates to a method of manufacturing an actuator for a micro ejector, and more particularly, to a method of machining and manufacturing a small actuator provided in a micro ejector capable of ejecting a sample in picoliter to nanoliter amounts.

2. Description of the Related Art

Biotechnology is one of the most prominent technologies among highly developed modern advanced technologies. Biotechnology research has mainly used samples directly or indirectly associated with living organisms. Biotechnology needs a microfluid system able to transport and control, or allow for the analysis of, a fluid (in particular a microfluid sample present in a carrier in a dissolved state).

The microfluid system is manufactured based on micro electro mechanical system (MEMS) technology. Micro electro mechanical systems have been used in various fields, such as for the injection of a drug or bioactive material, a lab-on-a-chip, chemical analysis for new medicine development, inkjet printing, a small cooling system, a small fuel cell, or the like. An example of microfluid systems used in the above-mentioned fields may include a micro ejector.

The micro ejector includes an actuator for ejecting samples such as a drug, blood, a reagent, or the like. As the actuator, a piezoelectric element made from a material such as lead zirconate titanate (PZT), or the like, is used, and may be manufactured as a wafer unit. The micro ejector may eject a sample in picoliter to nanoliter amounts.

Recently, however, since the supply of samples extracted from human patients or specific experimental animals has been greatly limited due to ethical issues, animal protection campaigns, and the like, there is a need to develop a micro ejector or an actuator for a micro ejector capable of ejecting an extremely small amount of a sample as maximally as possible.

However, when an actuator is reduced to a predetermined size or less, it may be difficult to manufacture an actuator capable of operating on the microscale, that is, may have difficulties in allowing for operation of the actuator to be switched to next operation. Therefore, the development of a method of manufacturing an actuator for a micro ejector is urgently needed so as to integrally solve the defects.

### SUMMARY OF THE INVENTION

An aspect of the present invention provides a method of manufacturing an actuator for a micro ejector capable of ejecting a sample in picoliter to nanoliter amounts.

According to an aspect of the present invention, there is provided a method of manufacturing an actuator for a micro ejector, including: forming a groove in a first surface of a piezoelectric element; attaching the first surface of the piezoelectric element to a substrate; and machining a second surface of the piezoelectric element.

The grooves may be formed in the piezoelectric element, thereby controlling the size of the piezoelectric element.

The method of manufacturing an actuator for a micro ejector may further include filling the groove with resin.

The filling of the resin in the groove maybe performed to include forming a uniform bonding surface between the first surface of the piezoelectric element and the substrate.

Further, the resin filled in the grooves may serve as maintaining the shape of the piezoelectric element, thereby significantly reducing change in the position of the piezoelectric element or deformation in the shape of the piezoelectric element at the time of machining the piezoelectric element and moving thereof.

The machining of the second surface may further include removing the resin filled in the grooves.

According to the embodiment of the present invention configured as described above, a phenomenon in which the motion of the piezoelectric element is hindered by the resin may be reduced.

The forming of the groove may include forming a first groove and a second groove to be symmetrical with each other based on a longitudinal bisector of the piezoelectric element.

The interval between the first groove and the second groove may be controlled, thereby arbitrarily controlling the size of the piezoelectric element according to the type of micro ejector to be produced.

A distance between the first groove and the second groove may be 1 to 10 mm.

The method according to the embodiment of the present invention configured as described above may be useful in manufacturing a small actuator ejecting a sample in picoliter to nanoliter amounts.

The machining of the second surface may include removing an outer side based on the first groove and the second groove from the second surface of the piezoelectric element.

The first groove and the second groove may be used as marks for aligning the piezoelectric element.

A depth h of the groove may be formed to satisfy the following Condition Equation 1:

0.5t<h<0.8t [Condition Equation 1]

where t is a thickness of the piezoelectric element.

In the embodiment of the present invention configured as described above, the groove may be formed to have a considerable depth to allow the machining of the second surface of the piezoelectric element to easily exposing the grooves. Therefore, according to the embodiments of the present invention, the piezoelectric element may be easily manufactured to have a required size through the grooves.

According to another aspect of the present invention, there is provided a method of manufacturing an actuator for a micro ejector, including: forming a groove in a first surface of a piezoelectric element; filling the groove with resin; attaching a first surface of the piezoelectric element to a substrate; and polishing a second surface of the piezoelectric element so as to expose the grooves.

The piezoelectric element may be divided through the groove. Therefore, the embodiments of the present invention may be usefully used to manufacture the plurality of small piezoelectric elements using the single piezoelectric element.

The groove may have a width dividing the piezoelectric element in plural unit sizes and the groove may have a larger width than a length of the piezoelectric having the unit sizes.

The size (that is, the width) of the groove may be controlled to thus control an interval between piezoelectric elements having the unit size, thereby omitting the necessity of performing a process of aligning a plurality of piezoelectric elements at predetermined intervals.

The length of the piezoelectric elements having the unit sizes may be 1 to 10 mm.

The embodiment of the present invention may be useful to manufacture the small actuator ejecting the sample in picoliter to nano liter amounts.

A depth h of the groove may be formed to have a depth satisfying the following Condition Equation 1.

0.5t<h<0.8t [Condition Equation 1]

where t is a thickness of the piezoelectric element.

In the embodiment of the present invention configured as described above, the groove may be formed to have a considerable depth to allow the machining of the second surface of the piezoelectric element to easily expose the groove. Therefore, according to the embodiments of the present invention, the piezoelectric element may be easily manufactured to have a required size through the formation of the groove.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart showing a method of manufacturing an actuator for a micro ejector according to a first embodiment of the present invention;

FIG. 2 is a flow chart showing a method of manufacturing an actuator for a micro ejector according to a second embodiment of the present invention;

FIG. 3 is a flow chart showing a method of manufacturing an actuator for a micro ejector according to a third embodiment of the present invention;

FIG. 4 is a flow chart showing a method of manufacturing an actuator for a micro ejector according to a fourth embodiment of the present invention; and

FIG. 5 is a flow chart showing a method of manufacturing an actuator for a micro ejector according to a fifth embodiment of the present invention.

### DETAILED DESCRIPTION OF THE INVENTION

Hereinafter, embodiments of the present invention will be described in detail with reference to the accompanying drawings.

In describing the present invention below, terms indicating components of the present invention are named in consideration of functions of each component. Therefore, the terms should not be understood as being limited technical components of the present invention.

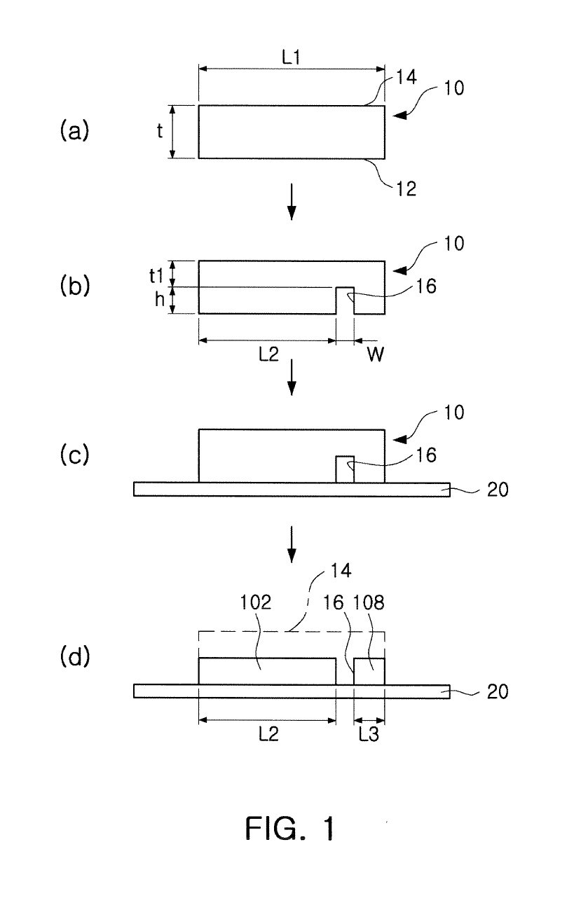

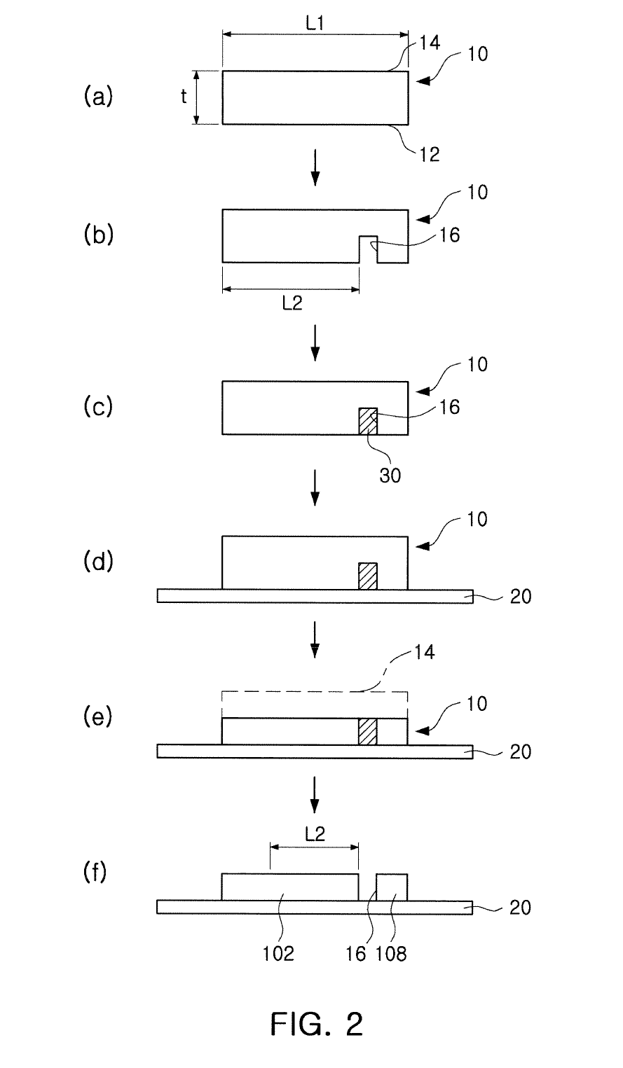

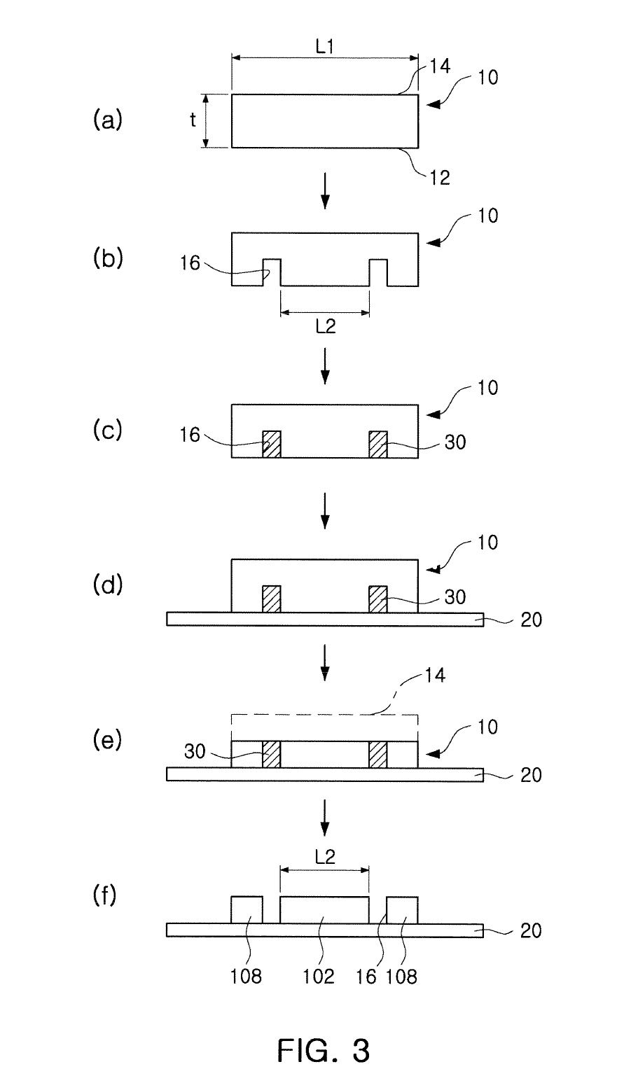

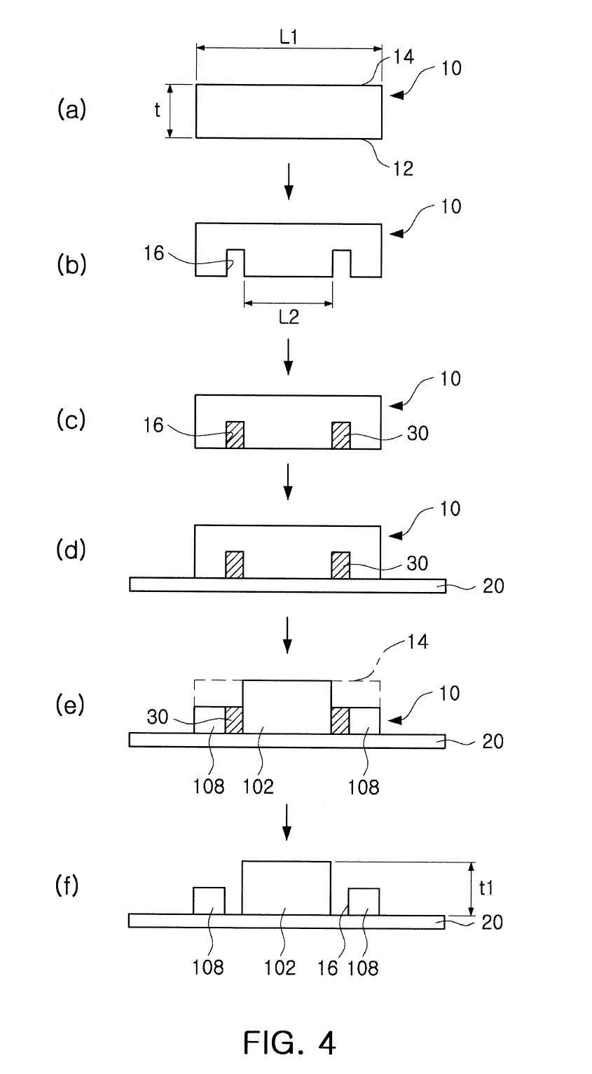

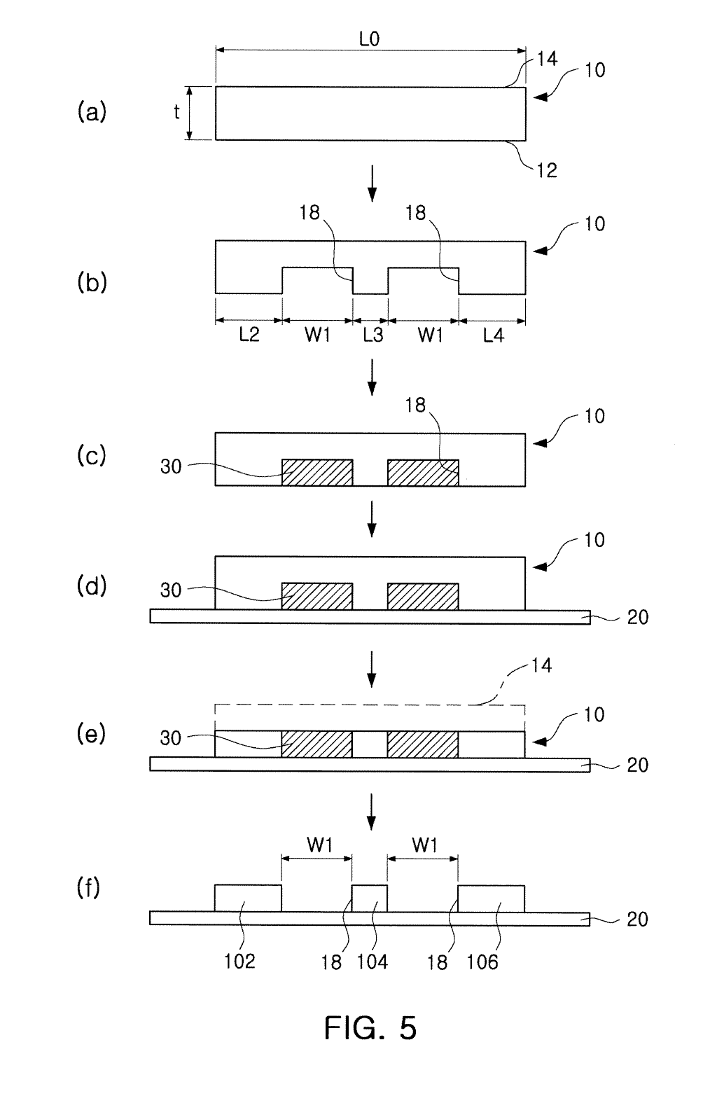

FIG. 1 is a flow chart showing a method of manufacturing an actuator for a micro ejector according to a first embodiment of the present invention, FIG. 2 is a flow chart showing a method of manufacturing an actuator for a micro ejector according to a second embodiment of the present invention, FIG. 3 is a flow chart showing a method of manufacturing an actuator for a micro ejector according to a third embodiment of the present invention, FIG. 4 is a flow chart showing a method of manufacturing an actuator for a micro ejector according to a fourth embodiment of the present invention, and FIG. 5 is a flow chart showing a method of manufacturing an actuator for a micro ejector according to a fifth embodiment of the present invention.

### First Embodiment

A method of manufacturing an actuator for a micro ejector according to a first embodiment of the present invention may include forming a groove, attaching the actuator, and machining an actuator.

For reference, in order to describe in detail the actuator, a piezoelectric element is used as the same meaning as the actuator. However, a change of a term should not be construed as a case in which the actuator is limited to the piezoelectric element but should be understood as one example of the actuator. That is, as the actuator of the first embodiment of the present invention, any member that may be vibrated and displaced by an electrical signal may be used.

1) Groove Formation

The forming of grooves may include forming a groove 16 in an actuator, that is, a piezoelectric device 10.

Generally, the piezoelectric device 10 may have a predetermined size or length L1 (hereinafter, referred to as a first length). However, the predetermined size or the first length L1 of the piezoelectric device may not be suitable for a micro ejector ejecting a sample in picoliter to nanoliter amounts. That is, the piezoelectric element 10 having the first length L1 may have a variable width to allow for the ejection of a sample ejected in an amount from tens of picoliters to nanoliter amounts larger than in an amount of several picoliters to nanoliters. In addition, the piezoelectric element 10 having the first length L1 may be a size that is not suitable for a mounting of the micro ejector. Therefore, in order to manufacture the micro ejector, the piezoelectric element needs to be machined so as be reduced to a size suitable for the micro ejector.

However, when the piezoelectric element 10 is reduced to a size suitable for the micro ejector, it may be difficult to attach the piezoelectric element 10 to other members (for example, a substrate, or the like) and to handle the piezoelectric element 10.

Therefore, in the present process, only the groove 16 may be formed in a first surface 12 of the piezoelectric element 10 without directly reducing the size of the piezoelectric element 10 so as not to affect the machining and handling of the piezoelectric element 10.

The groove 16 may be formed in the first surface 12 of the piezoelectric element 10. However, when the piezoelectric element 10 has a vertically symmetrical shape, the groove 16 may be formed in the second surface 14. That is, the groove 16 may be formed in any of the first surface 12 and the second surface 14 of the piezoelectric element 10.

The groove 16 may be formed to have a predetermined depth h from the first surface 12 of the piezoelectric element 10. The depth h of the groove 16 may satisfy the following Condition Equation 1 with reference to a thickness t of the piezoelectric element 10.

0.5t<h<0.8t [Condition Equation 1]

where h is the depth of the groove 16 and t is the thickness of the piezoelectric element 10.

In the Condition Equation 1, a lower bound may be a relative minimum depth of the groove 16 so as to secure the performance of the piezoelectric element 10.

That is, in the first embodiment of the present invention, the second surface 14 of the piezoelectric element 10 may be machined until the groove 16 is exposed to the outside.

Therefore, as shown in FIG. 1(d), the second surface 14 may have a thinner thickness h than an original thickness t.

However, when the piezoelectric element 10 is too thin, since the piezoelectric element 10 may not exhibit sufficient vibration characteristics, the minimum depth h of the groove 16 may be limited to thereby secure a relative minimum thickness of the piezoelectric element 10.

In the Condition Equation 1, an upper bound may be a maximum depth of the groove 16 so as not to cause the damage of the piezoelectric element 10.

That is, the piezoelectric element 10 is a thin film type of member and thus, may be damaged by an external impact. However, when the first surface 12 of the piezoelectric element 10 is provided with the groove 16, the piezoelectric element 10 may be broken during a process of attaching the piezoelectric element 10 to a member such as the substrate 20 or machining the piezoelectric element 10.

Therefore, a maximum depth h of the groove 16 may be limited so that the piezoelectric element 10 may have a sufficient thickness t1 at the portion where the groove 16 is formed.

The groove 16 may be formed at a position that is spaced apart by a distance L2 that is set from one side (a left side in the first embodiment) of the piezoelectric element 10 In this case, the set distance L2 may be a length L2 (hereinafter, referred to as a second length) of a piezoelectric element 102 necessary for the micro ejector.

In the first embodiment of the present invention, the groove 16 may be formed by a cutting machining. In this case, a width w of the groove 16 may be the same as a blade thickness of a cutting tool. Further, the groove 16 may be formed by repeatedly performing the cutting machining several times. In this case, the width w of the groove 16 may be larger than that of the blade thickness of the cutting tool.

In this case, when the width w of the groove 16 is relatively small, the strength may be secured at the portion where the groove 16 is formed. To the contrary, when the width w of the groove 16 is relatively large, it maybe easy to easily divide the piezoelectric element 10 through the groove 16.

Meanwhile, the groove 16 may be formed by a separate chemical process besides the cutting machining.

2) Attaching of Piezoelectric Element (Actuator)

The attaching of the piezoelectric element 10 may be performed to attach the piezoelectric element 10 to the substrate 20 or a fixing jig (not shown). For reference, in the attaching of the piezoelectric element 10, attaching may include the case in which the piezoelectric element 10 is permanently fixed to a specific member and the piezoelectric element 10 is arbitrarily fixed to the specific member.

The piezoelectric element 10 may be a thin and small member as described above. Therefore, in order to precisely machine the piezoelectric element 10, the piezoelectric element needs to be attached to the substrate 20 that is a portion of the micro ejector or the jig for machining.

The attachment of the piezoelectric element 10 may be performed using an adhesive, a double-sided tape, or the like. In this case, the adhesive may include a thermosetting resin. In addition, the double-sided tape may be formed to include a material of which the adhesion is changed at a predetermined temperature. For reference, the former may be usefully used for the case in which the permanent attachment of the piezoelectric element 10 is needed and the latter may be usefully used for the case in which the arbitrary attachment of the piezoelectric element 10 is needed.

Meanwhile, the alignment of the piezoelectric element 10 may be performed based on one side of the piezoelectric element 10. That is, the piezoelectric element 10 may be aligned on the substrate 20 based on one side of the piezoelectric element 10.

3) Machining of Piezoelectric Element (Actuator)

The machining of the piezoelectric element may be performed to machine the second surface 14 of the piezoelectric element 10.

That is, in the machining of the piezoelectric element, the second surface 14 may be machined so that the groove 16 may be exposed to the outside (the upper portion when being viewed from FIG. 1). The machining of the second surface 14 may be performed by the mechanical processing using a polishing mechanism. However, the machining of the second surface 14 is not limited to the above-mentioned processing but may be performed by a chemical process using chemicals.

In this case, the machining of the second surface 14 may be performed by one-time process, but in some cases, a single process may be repeatedly performed until the groove 16 is exposed.

When the machining of the piezoelectric element is completed, the piezoelectric element may be divided into a first piezoelectric element 102 having a unit size (that is, a size having the second length L2) and a second piezoelectric element 108 having any length L3. In this case, the second piezoelectric element 108 may have a very small size as compared with that of the first piezoelectric element 102 and may be provided as a portion which is not used as the actuator for the micro ejector. That is, the second piezoelectric element 108 may be removed through the separate additional processes. For example, the second piezoelectric element 108 may be removed by the polishing process or an etching process.

However, the second piezoelectric element 108 may be used as a mark for accurately aligning the first piezoelectric element 102 to the substrate 20 or other members, if necessary.

The method of manufacturing an actuator according to the first embodiment of the present invention configured by the above-mentioned processes may be applied to reduce the size of the piezoelectric element 10 in the state in which the piezoelectric element 10 is attached to the attached object (for example, the substrate 20), thereby reducing the phenomenon that the piezoelectric element 10 is separated from the attached object and facilitating the machining and handling of the piezoelectric element 10.

That is, in the related method, the piezoelectric element is attached to the attached object in the state in which the piezoelectric element is reduced to the required size, thereby degrading the adhesion between the piezoelectric element and the attached object and causing difficulties in handling the piezoelectric element.

However, in the method of manufacturing an actuator according to the first embodiment of the present invention, the piezoelectric element having a sufficient size may be first attached to the attached object and then, the piezoelectric element may be machined, thereby securing the sufficient bonding area between the piezoelectric element and facilitating the handling of the piezoelectric element.

In addition, in the method of manufacturing an actuator according to the first embodiment of the present invention, the size of the piezoelectric element 10 may be arbitrarily controlled by the relatively simple method of forming the groove 16 in the first surface 12 of the piezoelectric element 10, whereby the method may be appropriate for a miniaturization of the piezoelectric element 10.

In addition, in the method of manufacturing an actuator according to the first embodiment of the present invention, the formation of the piezoelectric element 10 and the machining of the second surface 14 of the piezoelectric element 10 may be collectively performed, thereby producing the plurality of piezoelectric elements in the wafer unit. That is, the method of manufacturing an actuator according to the first embodiment of the present invention may be appropriate for mass production of the small piezoelectric element.

Next, other embodiments of the present invention will be described with reference to FIGS. 2 to 5.

### Second Embodiment

Next, a second embodiment of the present invention will be described with reference to FIG. 2.

A method of manufacturing an actuator according to a second embodiment of the present invention may include forming a groove, filling a resin, attaching the actuator, machining the actuator, and removing a resin. For reference, the forming of the groove, the attaching of the actuator, and the machining of the actuator are the same as the first embodiment of the present invention and therefore, the detailed description of the processes will be omitted.

The second embodiment of the present invention may further include the filling of the resin and the removing of the resin.

The filling of the resin may include injecting a resin 30 into the groove 16 of the piezoelectric element 10 and may further include curing the injected resin.

As described in the first embodiment of the present invention, when the groove 16 is formed in the piezoelectric element 10, the strength of the portion where the groove 16 is formed may be relatively weakened. The second embodiment of the present invention may be performed to further fill a material such as the resin 30, or the like, in the groove 16 in consideration of the aspect.

As described above, the resin 30 filled in the groove 16 may reinforce the strength of the portion where the groove is formed and may increase the adhesion between the piezoelectric element 10 and the substrate 20. That is, the resin 30 may serve to increase a bonding area between the first surface 12 and the substrate 20 and serve as the adhesive fixing the piezoelectric element 10 to the substrate 20. For the latter, the curing process of the resin 30 may be performed in the state in which the piezoelectric element 10 is attached to the substrate 20. However, the curing process maybe performed prior to the process of attaching the piezoelectric element 10, if necessary.

Meanwhile, although the second embodiment of the present invention describes the resin 30 as the material filled in the groove 16, any material that may be injected into the groove 16 may be used.

The removing of the resin may be performed together in the machining of the second surface 14 of the piezoelectric element 10 as shown in FIG. 2(f). Alternatively, the removing of the resin may be separately performed after the machining of the second surface 14. The removing of the resin 30 may be performed by the chemical process using chemicals but may be performed by the separate machining tool, if necessary.

In the second embodiment of the present invention configured as described above, the resin 30 may be filled in the groove 16 as described above, thereby reducing the phenomenon that the piezoelectric element 10 is damaged at the portion where the groove 16 is formed.

### Third Embodiment

Next, a third embodiment of the present invention will be described with reference to FIG. 3.

A method of manufacturing an actuator according to a third embodiment of the present invention may include forming a groove, filling resin, attaching the actuator, machining the actuator and removing resin. For reference, the filling of the resin, the attaching of the actuator, the machining of the actuator, and the removing of the resin are the same as the second embodiment of the present invention and therefore, the detailed description of the processes will be omitted.

The third embodiment of the present invention may be differentiated from the above-mentioned embodiment in the forming of the groove. The forming of the groove according to the third embodiment of the present invention may include forming of two grooves 16 and 17 in the second groove 12 of the piezoelectric element 10 as shown in FIG. 3.

In this case, a distance between the first groove 16 and the second groove 17 may be the second length L2 suitable for the micro ejector. Herein, the first groove 16 and the second groove 17 may be symmetrical with each other based on a bisector C-C of the piezoelectric element 10. However, the positions of the first groove 16 and the second groove 17 may be changed, if necessary.

The third embodiment of the present invention may be appropriate for manufacturing the first piezoelectric element 102 having the second length L2 from the single piezoelectric element 10. For example, it is assumed that the first length L1 of the piezoelectric element 10 is twice longer than the second length L2 of the first piezoelectric element 102. In this case, when the first surface 12 of the piezoelectric element 10 is provided with the single groove 16, it may be difficult to differentiate the first piezoelectric element 102 from the second piezoelectric element 108. However, according to the third embodiment of the present invention, when the first surface 12 of the piezoelectric element 10 is provided with two grooves 16 and 17, it may be easy to easily differentiate the first piezoelectric element 102 from the second piezoelectric element 108.

Further, according to the third embodiment of the present invention, the second piezoelectric element 108 may be formed at both sides of the first piezoelectric element 102 and therefore, may be used as a mark for aligning the first piezoelectric element 102.

### Fourth Embodiment

Next, a fourth embodiment of the present invention will be described with reference to FIG. 4.

A method of manufacturing an actuator according to a fourth embodiment of the present invention may include forming a groove, filling resin, attaching the actuator, machining the actuator and removing resin. For reference, the forming of the groove, the filling of the resin, the attaching of the actuator, and the removing of the resin are the same as the third embodiment of the present invention and therefore, the detailed description of the processes will be omitted.

The fourth embodiment of the present invention may be differentiated from the third embodiment in the machining of the actuator. That is, the machining of the actuator according to the fourth embodiment of the present invention may include trimming only the second surface 14 of the second piezoelectric element 108 as shown in FIG. 4E.

The fourth embodiment of the present invention configured as described above may secure the vibration characteristics of the first piezoelectric element 102 since the thickness t1 of the first piezoelectric element 102 is the same as the thickness t of the piezoelectric element 10.

Further, in the fourth embodiment of the present invention, the second surface 14 of the first piezoelectric element 102 may not be machined, which may be usefully applied to the case in which the piezoelectric element 10 is relatively very thin.

### Fifth Embodiment

Next, a fifth embodiment of the present invention will be described with reference to FIG. 5.

A method of manufacturing an actuator according to a fifth embodiment of the present invention may include forming a groove, filling resin, attaching the actuator, machining the actuator and removing resin. For reference, the filling of the resin, the attaching of the actuator, the machining of the actuator, and the removing of the resin are the same as the second embodiment of the present invention and therefore, the detailed description of the processes will be omitted.

The fifth embodiment of the present invention may be differentiated from the above-mentioned embodiments in the forming of the groove and may be usefully applied to machine the piezoelectric element 10 having a relatively longer length L0. For example, the fifth embodiment of the present invention may be useful for the case when the single piezoelectric element 10 is machined so as to manufacture a piezoelectric element 102 having plural unit sizes.

The forming of the groove according to the fifth embodiment of the present invention may include forming a groove 18 having a relatively large width w1 as shown in FIG. 5. Herein, the groove 18 may be formed through a one-time machining process or a plural of machining processes. The piezoelectric element 10 may be divided into a first piezoelectric element 102, a second piezoelectric element 104, and a third piezoelectric element 106 according to the groove 18.

The width w1 of the groove 18 may be set to have a size to sufficiently secure an interval between the first piezoelectric element 102 and the second piezoelectric element 104 or an interval between the first piezoelectric element 102 and the third piezoelectric element 106. That is, in order to manufacture the piezoelectric elements 102, 104, and 106 attached to the substrate 20 as the actuator for the micro ejector, sufficient space is needed to perform the subsequent machining, whereby the width w1 of the groove 18 may be larger than that the second length L2.

The first piezoelectric element 102 and the third piezoelectric element 106 may be symmetrical with each other and the length L2 of the first piezoelectric element 102 and the length L4 of the third piezoelectric element 106 maybe the same as each other. In this case, the second piezoelectric element 104 may be provided as a portion that is not used for the micro ejector, and the length L3 of the second piezoelectric element 104 may be very small as compared with L2 or L4.

The fifth embodiment of the present invention may be used for the case in which the piezoelectric element 10 has a considerable length LO and may be useful to manufacture the plurality of small piezoelectric elements 102, 104, and 106, using the single piezoelectric element 10.

Meanwhile, although the above-mentioned embodiments describes the case that the single piezoelectric element 10 is attached to the substrate 20, a plurality of piezoelectric elements 10 may be disposed at a predetermined distance and these piezoelectric elements 10 may be collectively attached and machined, if necessary.

As set forth above, according to the embodiments of the present invention, the small actuator may be manufactured by controlling the size of the actuator (that is, a piezoelectric element) through the groove.

Further, according to the embodiments of the present invention, the handling of the actuator maybe facilitated and the phenomenon that the actuator is separated from the substrate during the machining process of the actuator may be greatly reduced by implementing all the manufacturing processes in the state in which the size of the actuator is not reduced.

While the present invention has been shown and described in connection with the embodiments, it will be apparent to those skilled in the art that modifications and variations can be made without departing from the spirit and scope of the invention as defined by the appended claims.

What is claimed is:

1. A method of manufacturing an actuator for a micro ejector, comprising:
forming a groove in a first surface of a piezoelectric element;
attaching the first surface of the piezoelectric element to a substrate; and
machining a second surface of the piezoelectric element.

2. The method of claim 1, further comprising filling the grooves with resin.

3. The method of claim 2, wherein the machining of the second surface further includes removing the resin filled in the groove.

4. The method of claim 1, wherein the forming of the groove includes forming a first groove and a second groove to be symmetrical with each other based on a longitudinal bisector of the piezoelectric element.

5. The method of claim 4, wherein a distance between the first groove and the second groove is 1 to 10 mm.

6. The method of claim 4, wherein the machining of the second surface includes removing an outer side based on the first groove and the second groove from the second surface of the piezoelectric element.

7. The method of claim 1, wherein a depth h of the groove satisfies the following Condition Equation 1:
0.5t<h<0.8t [Condition Equation 1]
where t is a thickness of the piezoelectric element.

8. A method of manufacturing an actuator for a micro ejector, comprising:
forming a groove in a first surface of a piezoelectric element;
filling the groove with resin;
attaching a first surface of the piezoelectric element to a substrate; and
polishing a second surface of the piezoelectric element so as to expose the groove.

9. The method of claim 8, wherein the groove has a width dividing the piezoelectric element in plural unit sizes.

10. The method of claim 9, wherein the groove has a larger width than a length of the piezoelectric element having the unit sizes.

11. The method of claim 9, wherein the length of the piezoelectric element having the unit sizes is 1 to 10 mm.

12. The method of claim 8, wherein a depth h of the groove is formed to have a depth satisfying the following Condition Equation 1
0.5t<h<0.8t [Condition Equation 1]
where t is a thickness of the piezoelectric element.
